(19) United States
(12) Patent Application Publication
(10) Pub. No.: US 2022/0335227 A1
(43) Pub. Date: Oct. 20, 2022

(54) MACHINE TRANSLATION GUIDED BY REFERENCE DOCUMENTS

(71) Applicant: DEEPTRANSLATE LIMITED, Hong Kong (CN)

(72) Inventors: Mee Yee CHAN, Hong Kong (CN); Francis Yuk Lun CHIN, Hong Kong (CN); Tung Yeung LAM, Hong Kong (CN); Linkai LUO, Hong Kong (CN); Chun Pong NG, Hong Kong (CN); Wu ZHANG, Hong Kong (CN)

(73) Assignee: DEEPTRANSLATE LIMITED, Hong Kong (CN)

(21) Appl. No.: 17/655,590

(22) Filed: Mar. 21, 2022

Related U.S. Application Data
(60) Provisional application No. 63/177,329, filed on Apr. 20, 2021.

(51) Int. Cl. G06F 40/45; G06F 40/58; G06F 40/49; G06F 40/44

(52) U.S. Cl. CPC G06F 40/45; G06F 40/58; G06F 40/49; G06F 40/44

(57) ABSTRACT

System and methods for a computerized machine translation of a document in a source language to a target language, where the translation is guided by additional inputs, which are one or more reference documents in the source language and their corresponding reference translation(s) in the target language, or are links thereto.

### TECHNICAL FIELD

Embodiments discussed herein generally relate to computer-aided translations and machine translations.

### BACKGROUND

Computer-aided translation or machine translation has evolved from a simple mapping of words from one language to another with the help of dictionaries to a more sophisticated mapping process that makes use of past translations of phrases and even entire sentences, which are saved in a database for retrieval and reuse. This approach enables a human translator to reuse previous translations and save time to complete the overall translation. However, the accuracy of the translation depends on the saved phrases or sentences in the database, although the accuracy may improve over time as the database grows bigger.

Even with the mapping of words from one language to another, there is often more than one translation of a single word and the context in which the word is used is important for the selection of the best translation of the word. As such, the database should contain a plurality of translations for phrases and sentences which are appropriate depending on different contexts. For example, the context may suggest that the translation should have a formal tone or style in contrast to an informal conversational tone or style. Although a human translator can manually verify or confirm the selection of the best translation of phrases or sentences in the given context, an automated approach can be taken in the selection process whereby the translation system provides a context-considered translation to the translator without a manual validation of the selection.

The question is: how do you communicate to the translation system the context and style of the translation that you want? While the source document may give information about the context, and in so doing, provide information about the desired style of the translation, often users are able to provide an example of what they want in terms of a similar reference document with a reference translation that the users particularly like. The phrases and sentences in the reference document and reference translation may not necessarily be already stored in the database of past translations for various reasons. For example, the machine translation system's database may be focused on consumer electronics news releases, but may lack sophistication or depth in other areas, such as legal, etc. In other situations, the database may not store information from the reference document and translation due to confidentiality.

Therefore, embodiments attempt to create a technical solution to address the challenges above.

### SUMMARY

Embodiments of the invention include a system and method for a machine translation of a source document from a source language to a target document in a target language guided by additional inputs that may be dynamically provided and not available from a stored database. In one embodiment, the additional inputs may be confidential and may not be shared or portions of it may not be stored due to strict confidentiality requirements. In one embodiment, the additional inputs may include one or more reference documents in the source language and their corresponding reference translation(s) in the target language. In another embodiment, the reference document and reference translation may be provided via a link dynamically.

In another embodiment, the additional inputs may include expectations about the translation of the source document at a sentence level or a phrase level. In a further embodiment, the sentence or phrase used in the reference translation may be selected or preferred over pre-existing translations of the same sentence or phrase, if any.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a system diagram for a reference aided machine translation system according to some embodiments.

FIG. 2 is another system diagram for a reference aided machine translation system according to some embodiments.

FIG. 3 is a flowchart illustrating a computerized method for a reference aided machine translation according to one embodiment.

FIG. 4 is another flowchart illustrating a computerized method for a reference aided machine translation according to one embodiment.

FIG. 5 is a diagram illustrating a data construct or model for a reference aided machine translation according to some embodiments.

FIG. 6 is a diagram illustrating a portable computing device according to one embodiment.

FIG. 7 is a diagram illustrating a computing device according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, Embodiments of the invention may be embodied as methods, systems, computer readable media, apparatuses, or devices. Accordingly, Embodiments of the invention may take the form of an entirely hardware embodiment, an entirely software embodiment, or an embodiment combining software and hardware aspects. The following detailed description may, therefore, not to be taken in a limiting sense.

Human translators often use or consult reference documents to guide their translations. Aspects of the invention take into account that reference documents and/or their translations may be available only shortly before the translation is needed. For example, due to confidentiality, clients may not have anything other than a vague idea of the translation or what the translation should look like in advance. With the short turnaround time and confidentiality requirements, typical machine translation approaches of building a robust database or training a neural network cannot be applied.

In another example, a translation client may give a translator a base document while providing a sample of a similar document. The client may then request the human translator to translate the base document so that the translation may adopt the style and terminology of the sample. In another example, a translator of this year's annual report for a company may use the translation of the previous year's annual report to guide the translation.

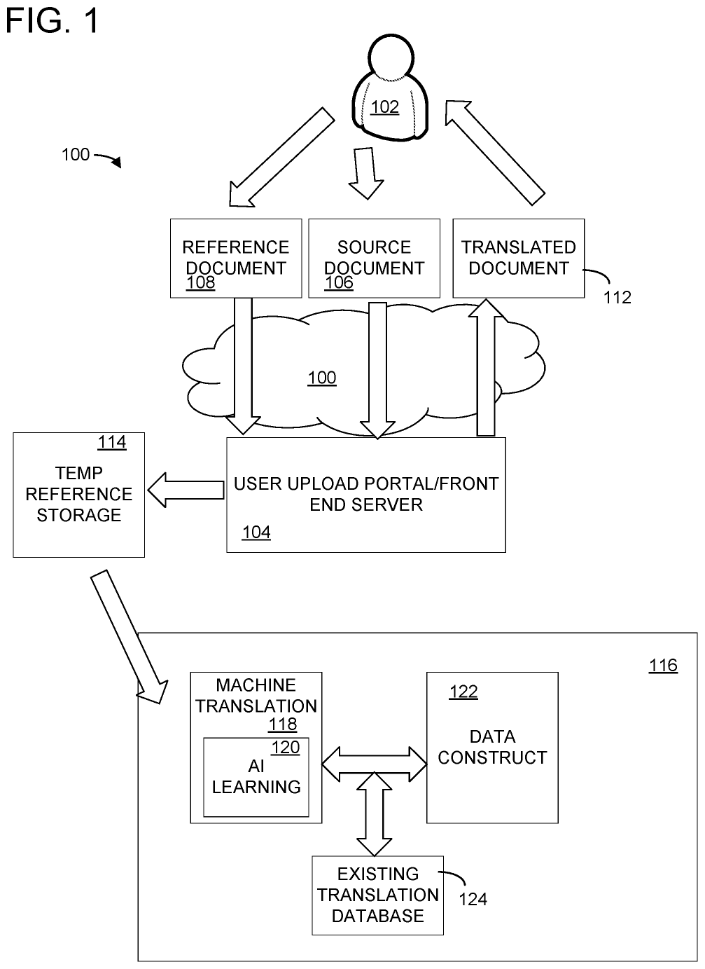

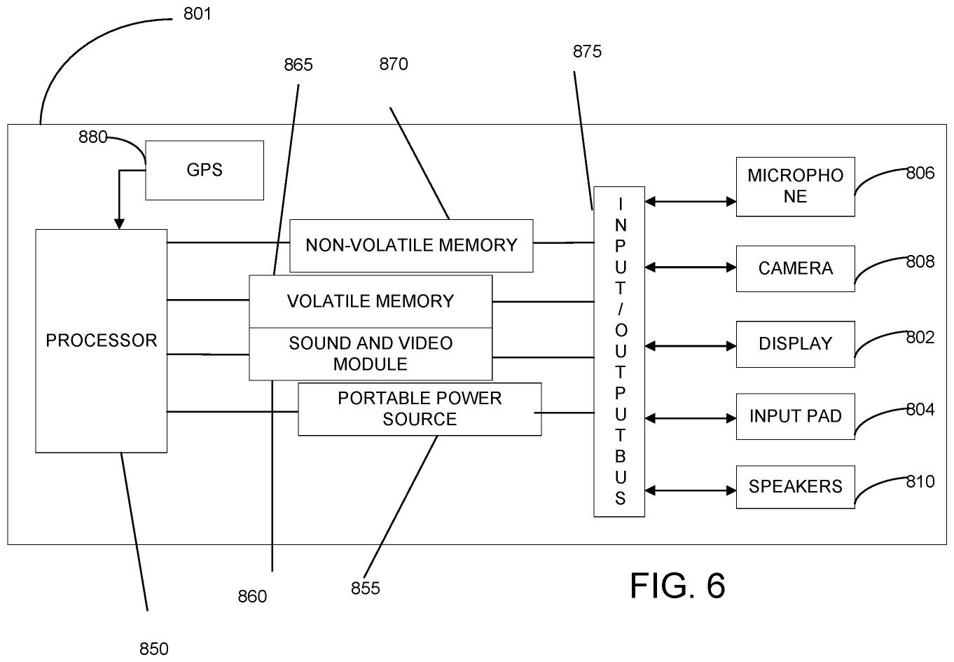

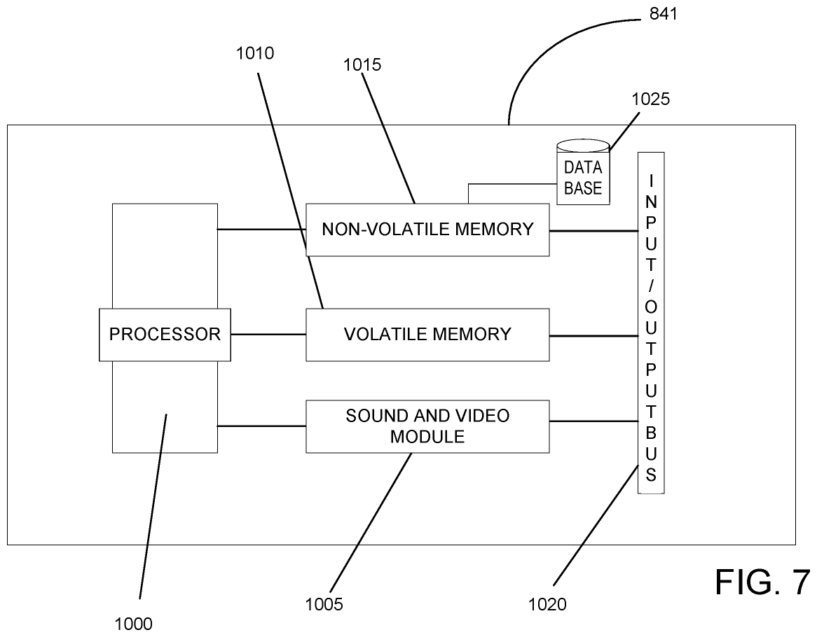

Given these challenges, aspects of the invention enable additional inputs function as a way of communicating, by example, the expectations of a user (e.g., a client or a party requesting the translation) regarding the target document. Referring to FIG. 1, a distributed or cloud-based system 100 for a reference aided machine translation according to some embodiments of the invention. In such an embodiment, the system 100 is a cloud-based or a distributed computer system where servers (e.g., 841 of FIG. 7) may be deployed in different geographical regions to handle requests from a user 102. The user 102 may initiate the request for a translation by first submitting a request (not shown) to a frontend server 104 via a user device, such as a device 801 in FIG. 6. In one aspect, the request may indicate a source or first language and a target or second language. In another embodiment, the user 102 may indicate the source language and one or more target languages. In another embodiment, the request may further include a source document 106. The source document 106 may be a fully completed document in the source language to be translated. In another embodiment, the source document 106 may include a summary of the changes to be made to a reference document 108. In yet another embodiment, the source document 106 may be a text-based document. In another embodiment, the source document may be an image that may include edits or handwritten notes.

In some embodiments, the reference document 108 may be a sample document similar to the source document. For example, the reference document 108 may be a prior year's annual financial report of a company that may be deemed similar to the source document. As such, the reference document 108 may include charts, tables, graphs, or the like. With such annual financial report as the reference document 108, the source document 106 may be notes or summary of changes to the prior annual report and the desired translated document 112 may be an annual financial report for this year. In another embodiment, the reference document 108 may be a glossary of terms. In some embodiments, the reference document 108 may be provided directly via an upload, an email, or other submission by the user 102. In another embodiment, the reference document 108 may also be provided via a link or a hyperlink to the actual reference document 108 by the user 102.

A reference translation 110 of the reference document 108 may be provided or uploaded by the user 102. In another embodiment, the reference translation 110 may also be provided via a link or a hyperlink to the actual reference translation 110 by the user 102. The reference translation 110 may be a complete or partial translation of the reference document 108.

The frontend server 104 may further request the user 102 to provide some basic information, such as name, contact information or the like. The frontend server 104 may also request the user 102 to establish an account so that payment information or other information may be associated with the user 102. In one example, the frontend server 104 may provide a temporary storage for the user 102 depending on account levels or a profile of the user 102. For example, a premium account level may include a larger storage size or allowance than a gold or silver account level. In yet another embodiment, the account may further provide an alert capability when the translated document 112 may be available or other notifications alerting the user 102 that other information may be needed.

In some embodiments, the frontend server 104 may receive the source document 106, the reference document 108, and the reference translation 110 from the user 102 via direct upload, email or other known approaches. In one aspect, the system 100 may receive these documents as one upload (e.g., one file) and the user 102 may identify page delineations to separate the documents. In another embodiment, the system 100 may preliminarily separate them based on its artificial intelligence (AI) machine identification and may prompt the user 102 for confirmation or verification. Once received, the system 100 may store these documents in a temporary reference storage 114. In one embodiment, the user 102 may view the storage so that the user 102 may delete the documents from the storage after receiving the translated document 112. In another embodiment, the temp reference storage 114 may purge the documents periodically or in response to a trigger, such as the translated document 112 is completed or 7 days have passed since the payment for the translation has been received, or the like. It is to be understood that other trigger or conditions may be used for the purge action to take place without departing from the spirit and scope of the embodiments.

In some embodiments, the system 100 may include a backend server 116 that further perform analysis and processing of the request. For example, the backend server 116 may include one or more processors executing computer-executable instructions. In another embodiment, the server 116 may access databases or other devices in a distributed network manner. Further, in some embodiments, the server 116 may execute programs, algorithms, or other computer-executable instructions that perform machine translations. For example, a machine translation module 118 may include software programs that take the source document 106, the reference document 108, and the reference translation 110 as input and provide the translated document 112 as output. In another embodiment, the machine translation module 118 may include an AI neural network model 120 whose parameters have been set with pre-training using supervised or unsupervised learning before subsequent use of these parameters for inference during translation. The server 116 may further provide or store a data construct 122 for the reference document 108 and reference translation 110 to aid the machine translation module 118 to translate the source document. In yet some embodiments, the server 116 may access an existing translation database 124 that may include terms or words already known. In one embodiment, the existing translation database 124 may include a translation memory of a collection of words, phrases, sentences, or the like of different languages.

In one aspect, the reference document 108 may include underlying user expectations of the end product—the translated document 112. For example, the expectations may include the following:

(1) a sentence appearing in both the source document and the reference document(s) would have the same translation in the target document and in the corresponding reference translation(s);

(2) a similar pair of sentences, one in the source document and the other in the reference document(s), may have similar translation in the target document and in the corresponding reference translation(s);

(3) names and special terminology in the source document which may be found in the reference document(s) will have the same translation in the target document and in the corresponding reference translation(s); and

(4) where there are multiple possible or candidate translation of words or phrases in the source document based on existing translation database, the translation in the target document may select or adopt the translations of such words or phrases used in the reference translations regardless of the matching or scoring of the possible or candidate translations.

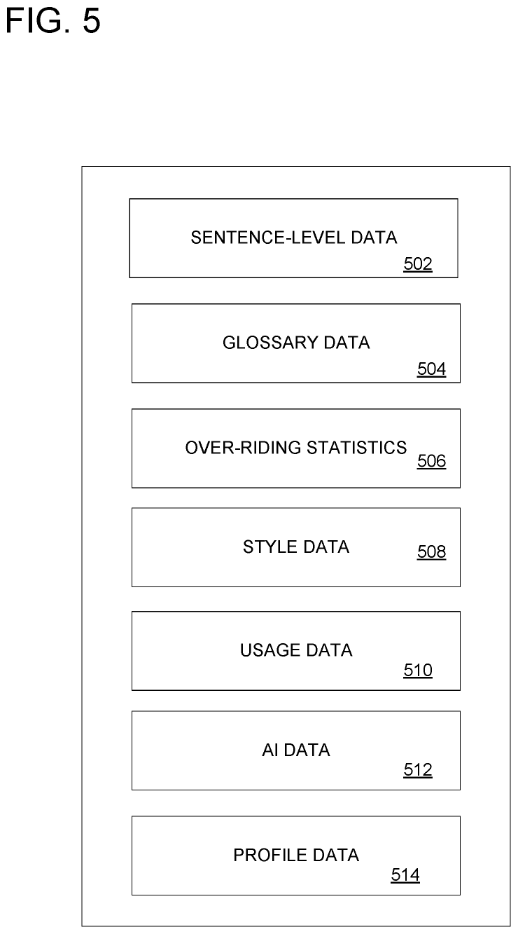

Based on the expectations above, the server 116 may build or construct the data construct 122 for each of the requests or each of the reference documents and their corresponding translations, which will be discussed in relation to FIG. 5.

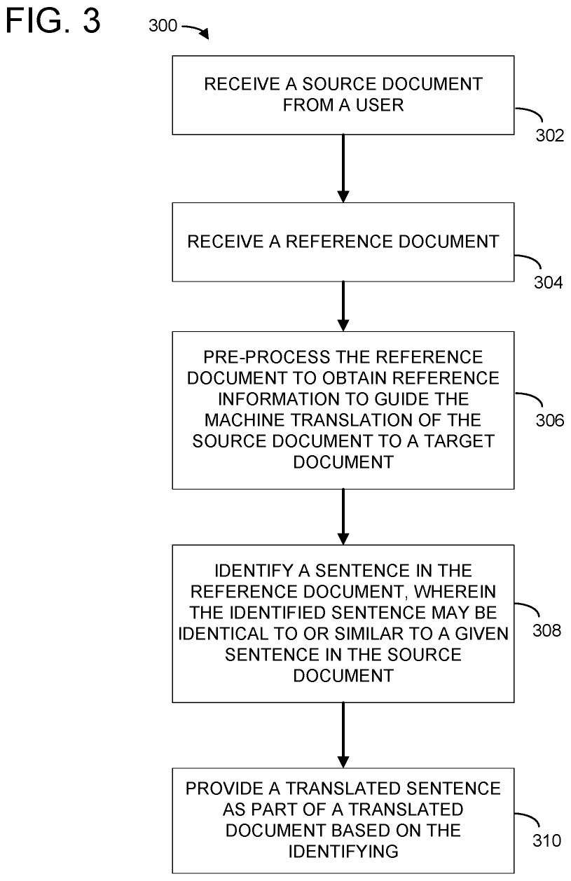

Referring now to FIG. 3, a flowchart 300 illustrates a computer-implemented method for a reference aided machine translation according to some embodiments. In one example, at 302, a source document (e.g., the source document 106) may be received by the system 100. In one example, as discussed above, the user 102 may upload or send the source document to the system 100. In another example, the source document may be transmitted to the system 100 via file transfer protocol (FTP) or other electronic data transfer means.

In a further embodiment, at 304, reference document(s) (e.g., the reference document 108) and their translation(s) (e.g., the reference translation 110) may be received by the system 100, either at same time or separately. These reference documents and their translations may be in the same file or document or separate documents. As discussed with examples above, the reference document 108 may be a document similar to the source document. At 306, the system 100 may pre-process the reference document(s) and corresponding reference translation(s) to obtain reference information to guide a translation of the source document to a target document.

In one embodiment, the pre-processing may include building a translation glossary for names and special terminology in the reference document 108. In one embodiment, the identification of special terminology may perform a word-based statistical analysis and identify parameters such as statistical frequency of words and phrases in the reference document 108 as compared with the frequency of these words and phrases in general. In another embodiment, this analysis may further include reviewing the existing translation database and comparing usage of the words in the reference document 108 against that of the existing translation database. In one embodiment, the pre-processing may include building a language model or a content model from the reference document 108 and the reference translation 110.

At 308, the system 100 may consider a sentence in the source document 106 in turn. For example, the system 100 may identify a sentence in the reference document 108, which may be identical to or similar to the sentence from the source document being considered, and its corresponding translation thereof at 310. In one example, the sentence may be a collection of words, such as a phrase. In another example, the sentence may be a sequence of words before a period or full stop or line break. In another embodiment, the sentence may be treated as a translation entity that is bound by periods or line breaks.

In a further example, the consideration of the sentence or the translation entity in the source document at 308 may further include extracting words from the sentence and identifying possible or candidate translations of the extracted words.

At 310, the system 100 may provide a translation of the sentence or the translation entity in the source document 106 being considered where the machine translation is guided by the reference information obtained from the reference document(s) and corresponding reference translation(s), or from the sentences therein at 308. In one example, during the translation, the system may compare the possible or candidate translations to the glossary or special terms identified in the reference document. If the comparison is positive, the translation of the glossary term in the reference document is selected or used in the translated document 112. On the other hand, if the comparison is negative, the translated document 112 may include the most relevant translation based on the existing translation database or may use the translation result from the AI neural network model 120.

In yet another embodiment, constrained decoding for neural machine translation with constraints being the words or phrases that should appear in the translation may be used to further refine the translated document 112. In one example, the constrained decoding may use terminology constraints at decoding time, ensuring that the terminology is included in the output, the target document or the translated document. In a further embodiment, aspects of the invention may provide a data construct on an ad hoc or on reference document basis to build a language model or content model from the reference document and its translation to influence the decoding for neural machine translation.

Referring now to FIG. 5, a data structure 500 includes one or more data fields for storing data for a reference aided machine translation according to some embodiments. In one example, a data field 502 may store data relating to sentence-level data, such as how many words in the sentence, where the sentence is in the paragraph, is the sentence a heading, or the like. A data field 504 may store data relating to glossary data, such as how many terms are in the glossary, or the like. A data field 506 may store data relating to over-riding statistics. For example, the data in the data field 506 may include how many times the glossary data from the reference document over-rides or replaces the unguided or existing translation database, or the like.

In yet another embodiment, the data structure 500 may further store data in a data field 508 relating to style data. For example, style data may include active voice, passive voice, how many legalese terms, or the like. A data field 510 may further store data relating to usage data. For example, the usage data may include how many reference documents, when it is uploaded or accessed, whether different versions are used or sent, the user who uploads the document, the time of the upload, or the like. A data field 512 may store data relating to AI. For example, the AI data may include when the machine learning access the reference data, how many times the neural machine algorithms access the reference document as part of its learning or translation, or the like. The data structure 500 may further include a data field 514 for storing data relating to profile data. The profile data may include data on the user, the user account, the user's business, or the like. In one example, the profile data may further include links or external information accessed by the system 100 or provided by the user 102.

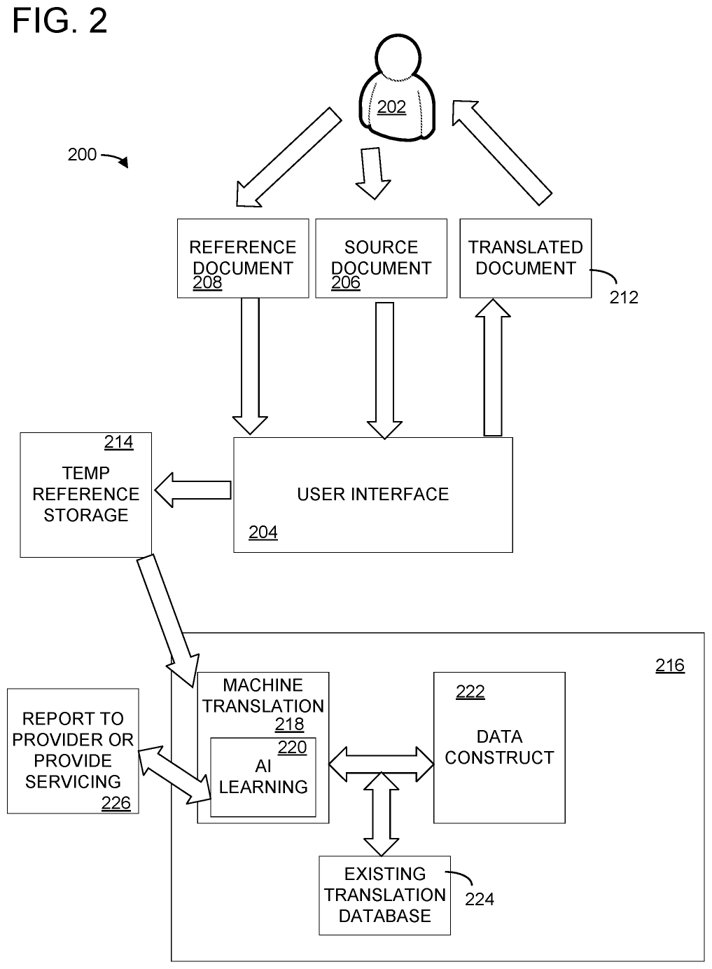

Referring to FIG. 2, system 200 is a reference aided machine translation according to another embodiment. In one embodiment, the system 200 is a client device where the machine translation capability is injected into the client device 200 via a software program, an application program, or an app. In such an embodiment, the system 200 may be a portable device (e.g., 801 of FIG. 6). The user 202 may initiate the request for a translation by first opening the machine translation software 218 via a user interface (UI) 204 so that the UI 204 may access the source document 206. In one aspect, the user action in opening the machine translation software 218 may indicate a source or first language and a target or second language. In another embodiment, the machine translation software 218 may be implemented as a plug-in or an add-in to another software so that its functionalities may be exposed to the other software while running in the background or running until trigger. In another embodiment, the user 202 may indicate the source language and one or more target languages. The source document 206 may be a fully completed document in the source language to be translated. In another embodiment, the source document 206 may include a summary of the changes to be made to a reference document 208. In yet another embodiment, the source document 206 may be a text-based document. In another embodiment, the source document may be an image that may include edits or handwritten notes.

In some embodiments, the reference document 208 may be a sample document similar to the source document. For example, the reference document 208 may be a prior annual financial report of a company that may be deemed highly confidential. As such, the reference document 208 may include charts, tables, graphs, or the like. With such annual financial report as the reference document 208, the source document 206 may be notes or summary of changes to the prior annual report and the desired translated document 212 may be an annual financial report for this year. In another embodiment, the reference document 208 may be a glossary of terms. In some embodiments, the reference document 208 may be provided directly via an upload, an email, or other submission by the user 202. In another embodiment, the reference document 208 may also be provided via a link or a hyperlink to the actual reference document 208 by the user.

A reference translation 210 of the reference document 208 may be provided or uploaded by the user 202. In another embodiment, the reference translation 210 may be provided via a link or a hyperlink to the actual reference translation 210 by the user 202. As the system 200 may be tailored to a client device, the link or hyperlink may point to an internal network data storage area, such as a network drive location. The reference translation 210 may be a complete or partial translation of the reference document 208.

In some embodiments, the UI 204 may receive the source document 206, the reference document 208, and the reference translation 210 from the user 202 via direct upload, email or other known approaches. In one aspect, the system 200 may receive these documents as one upload (e.g., one file) and the user 202 may identify page delineations to separate the documents. In another embodiment, the system 200 may preliminarily separate them based on its artificial intelligence (AI) machine identification and may prompt the user 202 for confirmation or verification. Once received, the system 200 may store these documents in a temporary reference storage 214. In one embodiment, the user 202 may view the storage so that the user 202 may delete the documents from the storage after receiving the translated document 212. In another embodiment, the temp reference storage 214 may purge the documents periodically or in response to a trigger, such as the translated document 212 is completed or 7 days have passed since the translation has been received, or the like. It is to be understood that other trigger or conditions may be used for the purge action to take place without departing from the spirit and scope of the embodiments.

In some embodiments, the system 200 may include one or more processors or microprocessors with one or more core executing computer-executable instructions. In another embodiment, the processor 216 may access database within the client device or other devices in a distributed network manner. Further, in some embodiments, the processor 216 may execute programs, algorithms, or other computer-executable instructions that perform machine translations. For example, a machine translation module 218 may include software programs that take the source document 206, the reference document 208, and the reference translation 210 as input and provide the translated document 212 as output. In another embodiment, the machine translation module 218 may include an AI neural network model 220 whose parameters have been set with pre-training using supervised or unsupervised learning before subsequent use of these parameters for inference during translation. The processor 216 may further provide or store a data construct 222 for the reference document 208 and reference translation 220 to aid the machine translation module 218 to translate the source document. In yet some embodiments, the server 216 may access an existing translation database 224 that may include terms or words already known. In one embodiment, the existing translation database 224 may include translation memory of a collection of words, phrases, sentences, or the like of different languages.

In one embodiment, in the client device implementation in the system 200, the client may have strict rules so that the reference document 208, the reference translation 210 and the source document 206 may not be made available to a third party. As such, instead of allowing the temp reference storage 214 to be accessible, the third party, such as the software provider of the machine translation module 218 or the AI neural network model 220, may only provide or export report or provide servicing via 226. In one embodiment, the report in 226 may include an anonymized version of the data construct 222 so as not to violate the confidentiality agreement with the client but the anonym ized data construct 222 may assist and improve the machine translation module 218 and/or the AI neural network model 220 in future versions.

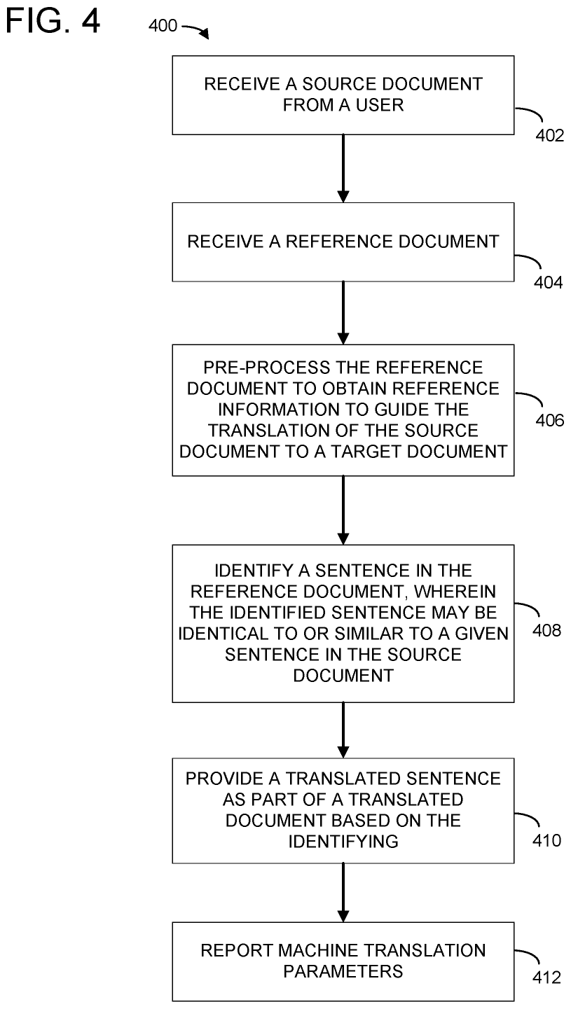

Referring now to FIG. 4, a flowchart 400 illustrates a computer-implemented method for a reference aided machine translation according to client-based embodiments. In one aspect, the steps in flowchart 400 may be performed by the system 200 as they are directed to a client-based or client device. In one example, at 402, a source document (e.g., the source document 206) may be received by the system 200. In one example, as discussed above, the user 202 may upload or send the source document to the system 200. In another example, the source document may be transmitted to the system 200 via file upload or file retrieval from the client system or a networked environment.

In a further embodiment, at 404, reference document(s) (e.g., the reference document 208) and their translation(s) (e.g. the reference translation 210) may be received by the system 200, either at same time or separately. These reference documents and their translations may be in the same file or document or separate documents. As discussed with examples above, the reference document 208 may be a document similar to the source document. At 406, the system 200 may pre-process the reference document(s) and corresponding reference translation(s) to obtain reference information to guide a translation of the source document to a target document.

In one embodiment, the pre-processing may include at least one or more of the following: building a translation glossary for: names and special terminology in the reference document 208. In one embodiment, the identification of special terminology may perform a word-based statistical analysis and identify parameters such as statistical frequency of words and phrases in the reference document 208 as compared with the frequency of these words and phrases in general. In another embodiment, this analysis may further include reviewing the existing translation database and comparing usage of the words in the reference document 208 against that of the existing translation database. In one embodiment, the pre-processing may include building a language model or content from the reference document and the reference translation 210.

At 408, the system 200 may consider a sentence in the source document 206 in turn. For example, the system 200 may identify a sentence in the reference document 208, which may be identical to or similar to the sentence from the source document being considered, and its corresponding translation thereof at 210. In one example, the sentence may be a collection of words, such as a phrase. In another example, the sentence may be a collection of words before a period or full stop. In another embodiment, the sentence may be treated as a translation entity that is bound by periods.

In a further example, the consideration of the sentence or the translation entity in the source document at 408 may further include extracting words from the sentence and identifying possible or candidate translations of the extracted words.

At 410, the system 200 may provide a translation of the sentence or the translation entity in the source document 206 being considered where the machine translation is guided by the reference information obtained from the reference document(s) and corresponding reference translation(s), or from the sentences therein at 408. In one example, during the translation, the system 200 may compare the possible or candidate translations to the glossary or special terms identified in the reference sentence. If the comparison is positive, the translation of the glossary term in the reference document is selected or used in the translated document 212. On the other hand, if the comparison is negative, the translated document 212 may include the most relevant translation based on the existing translation database or may use the translation result from the AI neural network model 220.

In yet another embodiment, constrained decoding for neural machine translation with constraints being the words or phrases that should appear in the translation may be used to further refine the translated document 212. In a further embodiment, aspects of the invention may provide a data construct on an ad hoc or on reference document basis to build a language model or content model from the reference document and its translation to influence the decoding for neural machine translation.

At 412, the system 200 may report at least a portion of the parameters of the machine translation module 218 to the service provider for further analysis, upgrade, or other servicing.

FIG. 6 may be a high level illustration of a portable computing device 801 communicating with a remote computing device 841 in FIG. 7 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 108 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi® (802.11 standard), BLUETOOTH, cellular communication or near field communication devices. The communication may be direct to the computing device 841 or may be through a communication network 102 such as cellular service, through the Internet, through a private network, through BLUETOOTH, etc., FIG. 6 may be a simplified illustration of the physical elements that make up a portable computing device 801 and FIG. 7 may be a simplified illustration of the physical elements that make up a server type computing device 841.

FIG. 6 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have non-volatile memory 865 and volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc., It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 7. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc., The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be computers that may have, among other elements, a microprocessor (such as from the Intel® Corporation, AMD®, ARM®, Qualcomm®, or MediaTek®); volatile and non-volatile memory; one or more mass storage devices (e.g., a hard drive); various user input devices, such as a mouse, a keyboard, or a microphone; and a video display system. The user devices, computers and servers described herein may be running on any one of many operating systems including, but not limited to WINDOWS®, UNIX®, LINUX®, MAC® OS®, iOS®, or Android®. It is contemplated, however, that any suitable operating system may be used for Embodiments of the invention. The servers may be a cluster of web servers, which may each be LINUX® based and supported by a load balancer that decides which of the cluster of web servers should process a request based upon the current request-load of the available server(s).

The user devices, computers and servers described herein may communicate via networks, including the Internet, wide area network (WAN), local area network (LAN), Wi-Fi®, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, Perl, or Python using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that Embodiments of the invention as described above may be implemented in the form of control logic using computer software in a modular or integrated manner. Based on the disclosure and teachings provided herein, a person of ordinary skill in the art may know and appreciate other ways and/or methods to implement Embodiments of the invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, when the reference document may not be readily available or may be of a sensitive nature, aspects of the invention provide a way to incorporate the style, context or usage of the terms from the reference document and its translation to the final translated document.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A computer-implemented method for a machine translation of a source document in a source language to a target document in a target language, comprising:
receiving the source document having a human readable content for content translation;
receiving a reference document and a reference translation, the latter being a translation of the former, in response to the receiving of the source document;
pre-processing the reference document and the reference translation by building a content model of the reference document and the reference translation;
identifying at least one translation entity in the source document; and
translating the at least one translation entity as a function of the content model of the reference document and reference translation.

2. The computer-implemented method of claim 1, wherein the reference document comprises at least one of the following: a partial sample document of the source document, a complete sample document of the source document, or a link to the reference document.

3. The computer-implemented method of claim 1, wherein the reference translation comprises at least one of the following: a partial translation of the reference document, a complete translation of the reference document, or a link to the reference translation.

4. The computer-implemented method of claim 1, wherein the translation entity comprises at least one of the following: a sequence of words bounded by a period, or a sequence of words bounded by a line break.

5. The computer-implemented method of claim 1, wherein building the content model comprises building a translation glossary of at least one term in the reference document and the reference translation.

6. The computer-implemented method of claim 1, wherein building the content model comprises building a special terminology, wherein building the special terminology further comprises performing a statistical analysis of frequency of words and phrases in the reference document and the reference translation as compared to the frequency of the words and phrases in general.

7. A computer-readable medium stored thereon computer-executable instructions for execution by a processor for a machine translation of a source document in a source language to a target document in a target language, wherein the computer-executable instructions comprising:
receiving from a first source the source document having a human readable content for content translation;
receiving a reference document and a reference translation, the latter being a translation of the former, from another source, in response to the receiving of the source document;
pre-processing the reference document and the reference translation by building a content model of the reference document and the reference translation;
identifying at least one translation entity in the source document; and
translating the at least one translation entity as a function of the content model of the reference document and the reference translation.

8. The computer-implemented method of claim 7, wherein the reference document comprises at least one of the following: a partial sample document of the source document, a complete sample document of the source document, or a link to the reference document.

9. The computer-implemented method of claim 7, wherein the reference translation comprises at least one of the following: a partial translation of the reference document, a complete translation of the reference document, or a link to the reference translation.

10. The computer-implemented method of claim 7, wherein the translation entity comprises at least one of the following: a sequence of words bounded by a period, or a sequence of words bounded by a line break.

11. The computer-implemented method of claim 7, wherein building the content model comprises building a translation glossary of at least one term in the reference document and the reference translation.

12. The computer-implemented method of claim 7, wherein building the content model comprises building a special terminology, wherein building the special terminology further comprises performing a statistical analysis of frequency of words and phrases in the reference document and the reference translation as compared to the frequency of the words and phrases in general.

13. A computer-programmed system for a machine translation of a source document in a source language to a target document in a target language comprising:
a processor configured to execute computer-executable instructions for a machine translation of a source document in a source language to a target document in a target language;
a database for storing a translation memory, wherein the translation memory comprises a collection of words, phrases, or sentences of different languages;
wherein the processor is configured to:
receiving from a first source the source document having a human readable content for content translation;
receiving a reference document, from another source, in response to the receiving of the source document;
pre-processing the reference document by building a content model of the reference document;
identifying at least one translation entity in the reference document; and
translating the at least one translation entity as a function of the content model of the reference document.

14. The computer-programmed system of claim 13, wherein the reference document comprises at least one of the following: a partial sample document of the source document, a complete sample document of the source document, or a link to the reference document.

15. The computer-programmed system of claim 13, wherein the reference translation comprises at least one of the following: a partial translation of the reference document, a complete translation of the reference document, or a link to the reference translation.

16. The computer-programmed system of claim 13, wherein the translation entity comprises at least one of the following: a sequence of words bounded by a period, or a sequence of words bounded by a line break.

17. The computer-programmed system of claim 13, wherein the processor is configured to build a translation glossary of at least one term in the reference document and the reference translation.

18. The computer-programmed system of claim 13, wherein the processor is configured to build a special terminology, wherein building the special terminology further comprises performing a statistical analysis of frequency of words and phrases in the reference document and the reference translation as compared to the frequency of the words and phrases in general.
